(19) United States
(12) Patent Application Publication
(10) Pub. No.: US 2006/0028780 A1
(43) Pub. Date: Feb. 9, 2006

(54) Method of creating electrostatic discharge protection in a microelectronic module

(76) Inventors: Peter Pessl, Nostl bei Weiz (AT); Franz Zangl, Bad Tolz (DE)

Correspondence Address: BRINKS HOFER GILSON & LIONE;INFINEON, PO BOX 10395, CHICAGO, IL, 60610, US

(21) Appl. No.: 11/168,244

(22) Filed: Jun. 27, 2005

(30) Foreign Application Priority Data
Jun. 29, 2004 (DE) 10 2004 031455.1

(51) Int. Cl. H02H 3/22

(52) U.S. Cl. 361/111

(57) ABSTRACT

A method and apparatus for creating electrostatic discharge (“ESD”) protection in a microelectronic module is disclosed. A semiconductor circuit comprises at least two independent voltage-supply domains, each of which comprises at least one bonding pad. The at least two bonding pads of the at least two independent voltage-supply domains are coupled together by an electrical connection, such as a bonding wire or a solder spot, which is routed outside the semiconductor circuit.

### RELATED APPLICATIONS

The present patent document claims priority to German Application Serial No. DE 10 2004 031455.1, filed Jul. 29, 2004, the entirety of which is hereby incorporated by reference.

### FIELD OF THE INVENTION

The present invention relates to a method and apparatus for creating electrostatic discharge (“ESD”) protection in a microelectronic module.

### BACKGROUND

A microelectronic module typically comprises a microelectronic circuit, or a semiconductor circuit, and a package which includes, inter alia, an interface of the microelectronic module to the outside world.

An adequate electrostatic discharge (“ESD”) protection for integrated circuits or microelectronic components requires a low-resistance discharge-current path. If the microelectronic module includes a plurality of independent voltage-supply domains, then, according to the prior art, it is necessary to establish between these independent voltage-supply domains a low-resistance electrical connection, established at least between the ground supplies or reference-potential supplies of the individual independent voltage-supply domains. This low-resistance electrical connection, which is also termed a ground-supply coupling, has the disadvantage that it results in disturbances from one independent voltage-supply domain being injected into another, adjacent, independent voltage-supply domain.

According to the prior art, the following methods exist for preventing the injecting-in of disturbances via a common ground network constructed from the low-resistance electrical connections.

A first method dispenses with the common ground network, and couples the independent voltage-supply domains via diodes, this resulting in a lesser ESD resistivity of the thus realized microelectronic modules than when the independent voltage-supply domains are coupled via a common ground network.

A second method of coupling between two independent voltage-supply domains provides for a coupling by means of a decoupling bow that is disposed between two pads of the respective independent voltage-supply domains. With this method, it is in each case necessary to add a pad of the respective independent voltage-supply domain, resulting in the problem of increasing the number of pads of the microelectronic module.

A third method dispenses with the common ground network, and the coupling is effected via diodes and extremely elaborate additional protective measures, this having the disadvantage of increasing the area requirement of the microelectronic module.

### BRIEF SUMMARY

The preferred embodiments of the current application are directed to providing a low-resistance electrical connection between independent voltage-supply domains, in such a way that disturbances from adjacent independent voltage-supply domains are not thereby injected-in and the disadvantages or problems of the previously described methods do not occur.

The preferred embodiments provide for a method for creating an ESD protection in the case of a microelectronic module comprising a semiconductor circuit which includes a first and a second independent voltage-supply domain which, in turn, respectively have at least one voltage-supply bonding pad, particularly for the purpose of being terminated to an external ground supply voltage or reference potential. In this case, there is established between the voltage-supply bonding pad of the first independent voltage-supply domain and the voltage-supply bonding pad of the second independent voltage-supply domain an electrical connection which is routed outside the semiconductor circuit and is realized by means of, for example, a bonding wire or a solder spot or solder globule.

The method according to some aspects of the invention has the following advantages. Since the electrical connection is routed outside the semiconductor circuit, the electrical connection does not affect the semiconductor circuit of the microelectronic module, but is realized in the package of the microelectronic module. The method according to some aspects of the invention therefore has no negative effect on the area requirement or on the number of pads of the semiconductor circuit. Furthermore, in comparison with a method in which the electrical connection is realized on the semiconductor circuit, it is very easy to deactivate, or break, the electrical connection between the first and the second independent voltage-supply domain for test purposes. By contrast, if the electrical connection is disposed on a semiconductor circuit, it is almost impossible to break such a connection without destroying the semiconductor circuit.

According to the preferred embodiments, the electrical connection can be provided with a higher inductance than that possessed by an electrical connection routed via a bonding wire which is as short as possible and is disposed, for example, between the voltage-supply bonding pad of the first independent voltage-supply domain and the voltage-supply bonding pad of the second voltage-supply domain.

Increasing the inductance advantageously effects better decoupling of, in particular, high-frequency disturbances. As a result, the injection of, for example, a disturbance from the first independent voltage-supply domain into the second independent voltage-supply domain via the electrical connection can be more effectively prevented. In connection with this, it is to be pointed out that, parameters being otherwise equal, the inductance increases with the length of the electrical connection, i.e., a longer electrical connection has a higher inductance.

In particular, the electrical connection can be routed via internal terminals within the package of the microelectronic module. For this purpose, the voltage-supply bonding pad of the first and second independent voltage-supply domains can be respectively connected, via a bonding wire or merely via a solder spot, to a first and second internal terminal respectively, these two internal terminals being electrically connected to one another. There are a plurality of possibilities, according to aspects of the invention, for the electrical connection of the two internal terminals. On the one hand, the two internal terminals can be electrically connected by a package interconnection which consists of a metal layer and is routed within the package. On the other hand, the electrical connection of the two internal terminals can be routed via further internal terminals of the package which, in turn, are electrically connected. In this case, the electrical connection can be effected between one of the two internal terminals and one of the further terminals, or between the further terminals, via a bonding wire or a package interconnection. In this case, the electrical connection between the two internal terminals can include an inductor, e.g. a coil.

In some embodiments of the present invention, a voltage-supply bonding pad of an independent voltage-supply domain can also be connected, via an electrical connection of its own, i.e., this electrical connection is not additionally used by another independent voltage-supply domain, to an external terminal of the package of the microelectronic module, the external terminal being connected to an external voltage supply, particularly a ground supply voltage or reference potential.

It is to be pointed out that the feature just described, that of establishing, for an independent voltage-supply domain, an electrical connection of its own to the external terminal via the corresponding voltage-supply bonding pad, is independent of the previously described feature, that of connecting two independent voltage-supply domains by means of an electrical connection.

Due to an independent voltage-supply domain being connected, via an electrical connection of its own, to the external voltage supply, the risk of this independent voltage-supply domain injecting-in disturbances from an adjacent independent voltage-supply domain is reduced, compared with the case in which this voltage-supply domain and the adjacent independent voltage-supply domain are connected to the external voltage supply via an at least partially common electrical connection.

In this case, the actual electrical connection between the independent voltage-supply domain and the external terminal, or the external voltage supply, can be effected via an internal terminal. For this purpose, for example, the voltage-supply bonding pad of the independent voltage-supply domain can be connected to this internal terminal via a bonding wire or a solder spot, and the internal terminal connected to the external terminal via a package interconnection. According to some aspects of the invention, one and the same internal terminal can serve both for the electrical connection between the voltage-supply domain and the external voltage supply, and for the electrical connection between the independent voltage-supply domain and an adjacent independent voltage-supply domain.

Since the same internal terminal is used for two electrical connections, the number of internal terminals to be used is advantageously reduced.

The preferred embodiment also provides for a microelectronic module comprising a semiconductor circuit which includes a first and a second independent voltage-supply domain, both of which have a respective voltage-supply bonding pad. In this case, there exists between these two voltage-supply bonding pads, and consequently between the two independent voltage-supply domains, an electrical connection which is routed outside the semiconductor circuit.

The advantages are the same as those that have been previously described in the description of the method for creating an ESD protection in the case of a microelectronic module, for which reason they are not repeated here.

The present invention is explained more fully in the following with reference to the appended drawings and preferred exemplary embodiments.

### BRIEF DESCRIPTION OF THE DRAWINGS

FIG. 1 shows one embodiment of a microelectronic module with electrostatic discharge (“ESD”) protection, wherein an inductor is inserted for decoupling independent voltage-supply domains; and

FIG. 2 shows another embodiment of a microelectronic module with ESD protection, comprising a decoupling between independent voltage-supply domains.

### DETAILED DESCRIPTION OF THE DRAWINGS AND THE PRESENTLY PREFERRED EMBODIMENTS

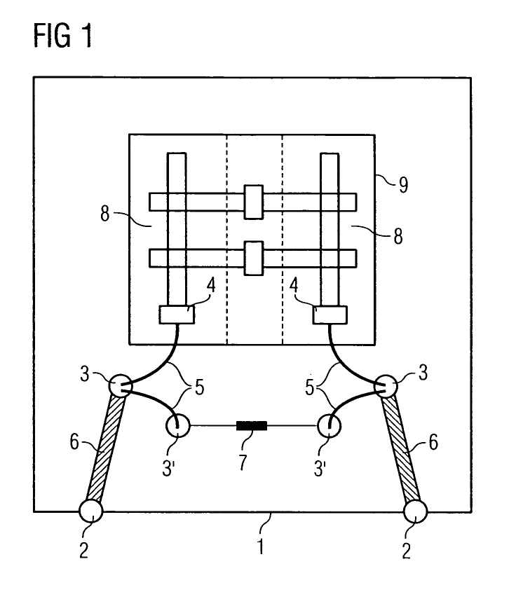

FIG. 1 shows a microelectronic module 1 comprising a semiconductor circuit 9 which has two independent supply-voltage domains 8. Each of these independent supply-voltage domains 8 has a supply-voltage bonding pad 4, which is connected to an internal terminal 3 via a bonding wire 5. (In other embodiments, the connection between the supply-voltage bonding pad 4 and the internal terminal 3 can also be realized merely by a solder spot instead of the bonding wire 5). Each of these internal terminals 3 is connected both to an external terminal 2 of the microelectronic module 1, via a package interconnection 6, and to a further internal terminal 3′, via a bonding wire 5. The two further internal terminals 3′ are connected to one another by means of an inductor 7, which can be, for example, a coil, whereby a low-resistance electrical connection having a high inductance is established between the supply-voltage bonding pads 4 of the two independent supply-voltage domains 8.

The electrostatic discharge (“ESD”) protection of the microelectronic module 1 is now to be described exemplarily with reference to FIG. 1. In the event of an electrostatic discharge of an independent voltage-supply domain 8, which discharge can be caused, for example, by contact by a person, the majority of this electrostatic discharge is dissipated, through the voltage-supply bonding pad 4, to the external terminal 2, via the path formed by the bonding wire 5, the internal terminal 3 and the package interconnection 6. In this case, the external terminal 2 is located on a supply potential, which can be a positive or a negative supply voltage or reference potential.

However, all of the energy of the electrostatic discharge cannot be dissipated via this previously described path. There is therefore a further propagation path, via the electrical connection of the two voltage-supply bonding pads 4, which path is routed via the inductor 7. Thus, the portion of the energy of the electrostatic discharge which is not dissipated via the external terminal 2 is evenly distributed to the two independent supply-voltage domains 8, as a result of which the loading of the affected independent supply-voltage domains 8 due to the electrostatic discharge is reduced.

The inductor 7 in the electrical connection between the two voltage-supply bonding pads 4 prevents a, usually high-frequency, disturbance produced in normal operation from being propagated via this electrical connection, since the electrical impedance of the inductor 7 increases with the frequency of the disturbance. In the case in which, for example, the one independent supply-voltage domain 8 is a digital circuit and the other independent voltage-supply domain 8 is an analog circuit, it is thereby possible to prevent disturbances caused by the digital circuit from spreading out to the analog circuit.

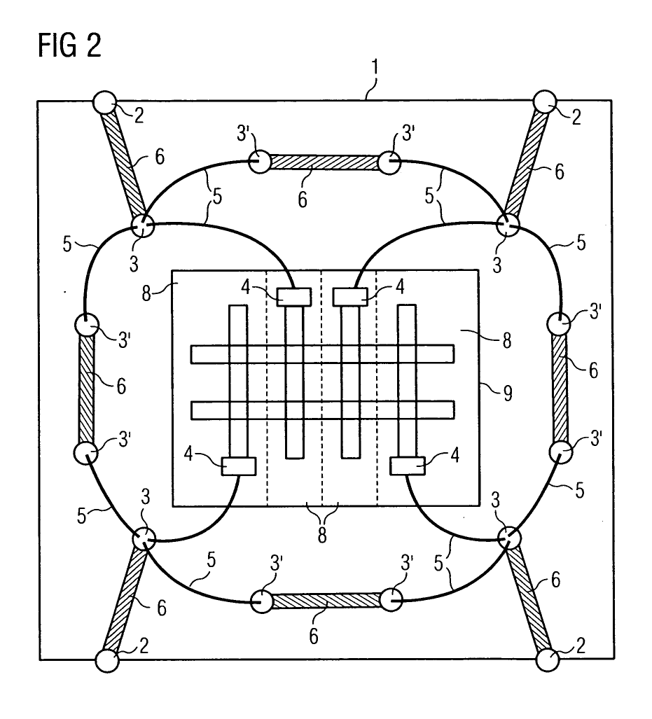

FIG. 2 shows a microelectronic module 1 which, in essence, is very similar to the microelectronic module 1 shown in FIG. 1, except that the microelectronic module 1 shown in FIG. 2 includes a semiconductor circuit 9 which is constructed from four independent voltage-supply domains 8. Each of these independent voltage-supply domains 8 has a voltage-supply bonding pad 4, by means of which the respective independent voltage-supply domain is supplied with reference potential via an external terminal 2 of the microelectronic module 1. Each of these voltage-supply bonding pads 4 is connected, via a bonding wire 5, to a respectively associated internal terminal 3 of the microelectronic module 1. Each of these in total four internal terminals 3, which are assigned to a respective voltage-supply bonding pad 4, is then connected to an external terminal 2 of the microelectronic module 1 via a package interconnection 6, each of the four external terminals 2 being connected to reference potential (not shown). In addition, each of the in total four internal terminals 3 is connected, via a bonding wire 5 in each case, to respectively two further internal terminals 3′ that are assigned to it. Two of these, in total eight, further internal terminals 3′ are respectively connected to a package interconnection 6. A ring is thereby constructed from the four internal terminals 3 and the eight further internal terminals 3′, together with the associated connections which, in the case of the embodiment shown, consist of bonding wires 5 and package interconnections 6. Through this ring, all four independent supply-voltage domains 8 are connected to one another, resulting in the construction of a very effective ESD protection, since the portion of the energy of an electrostatic discharge that is not dissipated via the external terminals 2 can propagate, via the ring, to all four independent supply-voltage domains 8, with the result that each independent supply-voltage domain 8 then only receives a fraction of this energy.

In the case of this embodiment, the bonding wires 5, which are inserted in the ring between respectively one of the four internal terminals 3 and one of the eight further internal terminals 3′, could of course be replaced, either singly or in total, by a package interconnection. Likewise, the package interconnections 6, which are inserted in the ring between respectively two of the eight further internal terminals 3′, could be replaced by bonding wires or, at least partially, by inductors.

In summary, FIG. 2 shows a microelectronic module 1 which, due to the previously described ring, has a very good ESD protection without the semiconductor circuit 9 having been expanded. In this case, each of the four independent supply-voltage domains has an electrical connection, assigned to it alone, to an external terminal 2 of the microelectronic module 1.

It is therefore intended that the foregoing detailed description be regarded as illustrative rather than limiting, and that it be understood that it is the following claims, including all equivalents, that are intended to define the spirit and scope of this invention.

1. A method for creating electrostatic discharge (“ESD”) protection in a microelectronic module comprising:
providing a semiconductor circuit comprising at least two independent voltage-supply domains, each independent voltage-supply domain comprising at least one voltage-supply bonding pad
establishing an electrical connection between a first voltage-supply bonding pad of a first independent voltage-supply domain of the at least two independent voltage-supply domains and a second voltage-supply bonding pad of a second independent voltage-supply domain of the at least two independent voltage-supply domains; and
routing the electrical connection outside the semiconductor circuit.

2. The method of claim 1, wherein:
the electrical connection has a higher inductance than a second electrical connection, the second electrical connection routed via a bonding wire that is the shortest distance possible between the first voltage-supply bonding pad and the second voltage-supply bonding pad.

3. The method of claim 1, further comprising:
establishing an electrical connection between the first voltage-supply bonding pad and a first internal terminal of the microelectronic module; and
establishing an electrical connection between the second voltage-supply bonding pad and a second internal terminal of the microelectronic module; and
establishing an electrical connection between the first and second internal terminals.

4. The method of claim 3, wherein the electrical connection between the first and second internal terminals comprises at least one inductor.

5. The method of claim 4 wherein the at least one inductor is a coil.

6. The method of claim 3, wherein the electrical connection between the first and second internal terminals is in the form of a ring.

7. The method of 3, further comprising:
establishing an electrical connection between the first internal terminal and a first external terminal connected to an external power supply; and
establishing an electrical connection between the second internal terminal and a second external terminal connected to the external power supply.

8. A microelectronic module comprising:
a semiconductor circuit comprising:
at least two independent voltage-supply domains, each independent voltage-supply domain comprising at least one voltage-supply bonding pad;
wherein a first voltage-supply bonding pad of a first independent voltage-supply domain of the at least two independent voltage-supply domains is electrically connected to a second voltage-supply bonding pad of a second independent voltage-supply domain of the at least two independent voltage-supply domains; and
wherein the electrical connection between the first and second independent voltage-supply bonding pads is routed outside the semiconductor circuit.

9. The microelectronic module of claim 8, wherein:
the first voltage-supply bonding pad is electrically connected to a first internal terminal of the microelectronic module;
the second voltage-supply bonding pad is electrically connected to a second internal terminal of the microelectronic module; and
the first and section internal terminals are electrically connected.

10. The microelectronic module of claim 9, wherein the electrical connection between the first and second internal terminals comprises at least one inductor.

11. The microelectronic module of claim 10, wherein the at least one inductor is a coil.

12. The microelectronic module of claim 9, wherein the electrical connection between the first and second internal terminals is in the form of a ring.

13. The microelectronic module of claim 9, wherein:
the first internal terminal is electrically connected to a first external terminal;
the second internal terminal is electrically connected to a second external terminal; and
the first and second external terminals are connected to an external voltage supply.

14. The microelectronic module of claim 13, wherein:
the first voltage-supply bonding pad supplies the first independent voltage-supply domain with a ground supply provided by the external voltage supply; and
the second voltage-supply bonding pad supplies the second independent voltage-supply domain with a ground supply provided by the external voltage supply.

15. A microelectronic module comprising:
a semiconductor circuit comprising:
a first independent voltage-supply domain comprising a first voltage-supply bonding pad;
a second independent voltage-supply domain comprising a second voltage-supply bonding pad;
a third independent voltage-supply domain comprising a third voltage-supply bonding pad; and
a fourth independent voltage-supply domain comprising a fourth voltage-supply bonding pad;
a first internal terminal electrically connected to the first voltage-supply bonding pad;
a first external terminal electrically connected to the first internal terminal;
a second internal terminal electrically connected to the second voltage-supply bonding pad;
a second external terminal electrically connected to the second internal terminal;
a third internal terminal electrically connected to the third voltage-supply bonding pad;
a third external terminal electrically connected to the third internal terminal;
a fourth internal terminal electrically connected to the fourth voltage-supply bonding pad; and
a fourth internal terminal electrically connected to the fourth internal terminal;
wherein the first, second, third and fourth internal terminals are electrically connected to each other in a ring formation.

15. The microelectronic module of claim 14, wherein:
the first, second, third, and fourth external terminals are connected to an external voltage supply.

16. The microelectronic module of claim 15, wherein:
the first voltage-supply bonding pad supplies the first independent voltage-supply domain with a ground supply provided by the external voltage supply;
the second voltage-supply bonding pad supplies the second independent voltage-supply domain with a ground supply provided by the external voltage supply;
the third voltage-supply bonding pad supplies the third independent voltage-supply domain with a ground supply provided by the external voltage supply; and
the fourth voltage-supply bonding pad supplies the fourth independent voltage-supply domain with a ground supply provided by the external voltage supply.

17. The microelectronic module of claim 14, wherein:
the electrical connection between the first and second internal terminals is created by at least one inductor;
the electrical connection between the second and third internal terminals is created by at least one inductor;
the electrical connection between the third and fourth internal terminals is created by at least one inductor; and
the electrical connection between the fourth and first internal terminals is created by at least one inductor.
